(19) United States
(12) Patent Application Publication
(10) Pub. No.: US 2009/0015582 A1
(43) Pub. Date: Jan. 15, 2009

(54) Short term residential spaces in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/827,774

(22) Filed: Jul. 13, 2007

(51) Int. Cl. G06T 15/00

(52) U.S. Cl. 345/419

(57) ABSTRACT

A method, apparatus, and system of short term residential spaces in a geo-spatial environment are disclosed. In one embodiment, a method includes generating a community network of user profiles, each profile associated with a specific geographic location, generating a first residential space identifier associated with a first user profile, and generating a first display view to include a three-dimensional map view embodied by the community network, the first residential space identifier, and the first user profile represented at a location in the three-dimensional map view associated with the specific geographic location of the first user profile. In addition, the method may also include simultaneously representing other user profiles adjacent to the first user profile in the three-dimensional map view. The method may also include simultaneously representing other user profiles adjacent to the first user profile of the user profiles in the three-dimensional map view.

### FIELD OF TECHNOLOGY

This disclosure relates generally to the technical fields of communications and, in one example embodiment, to a method, apparatus, and system of short term residential spaces in a geo-spatial environment.

### BACKGROUND

Travelers often need accommodations. Lodging may be expensive and/or availability may be limited. For example, travel planned on short notice may not offer enough time to book reservations in hotels. The travelers may not know in advance which nights they will need the accommodations, which may further limit the travelers' options.

The travelers may prefer to stay in a home-like setting or lease privately owned property, such as a home. For example, the travelers may prefer a home-like ambience. The home-like ambience may offer a “personal touch” of friendly hosts, including opportunities to build lasting friendships. Amenities may include home cooked meals, pet accommodations, childcare opportunities, attractive lease rates, and residential neighborhood settings.

The travelers, however, may not be able to locate such accommodations. Conversely, the hosts may not have a venue to offer such accommodations. Thus, both travelers and hosts may miss mutually rewarding accommodation opportunities.

### SUMMARY

A method, apparatus and system of short term residential spaces in a geo-spatial environment are disclosed. In one aspect, a method includes generating a community network of user profiles, each user profile associated with a specific geographic location, generating a first residential space identifier associated with a first user profile, and generating a first display view to include a three-dimensional map view embodied by the community network, the first residential space identifier, and the first user profile represented at a location in the three-dimensional map view associated with the specific geographic location of the first user profile.

In addition, the method may include simultaneously representing other user profiles adjacent to the first user profile in the three-dimensional map view. The method may also include generating residential space identifiers, each residential space identifier associated with a user profile, generating a search of the residential space identifiers based on at least one criterion, identifying at least one residential space identifier matching the criterion, and generating a second display view to include a three-dimensional map view embodied by the community network, at least one residential space identifier, and a second user profile associated with the residential space identifier represented at a location in the three-dimensional map view associated with the specific geographic location associated with the second user profile.

Furthermore, the method may include displaying reservation information in the first display view. The method may also include generating an online reservation and a financial transaction associated with the first residential space identifier. In addition, the method may also include associating the first residential space identifier with at least one type of accommodation associated with the specific geographic location of the first user profile. Furthermore, the method may include generating a visual representation associated with the accommodation, and displaying the visual representation associated with the first residential space identifier. The method may further include generating a wiki profile associated with the first user profile, and displaying the wiki profile associated with the first user profile. Moreover, the method may include generating content associated with the wiki profile, and displaying the content associated with the wiki profile.

In another aspect, a system includes a geo-spatial environment, a community network module of the geo-spatial environment, to include user profiles, each user profile to include a specific geographic location, a residential space identifier module of the geo-spatial environment to generate residential space identifiers associated with accommodations, each residential space identifier associated with the user profile, a map module of the geo-spatial environment to include map data which serve as a basis to render a three-dimensional map view in the geo-spatial environment which identifies at least some physical structures having specific geographic locations, and a display module of the geo-spatial environment to generate a display view of the three-dimensional map view embodied by the community network, a first user profile, and a first residential space identifier associated with the first user profile represented at a location in the three-dimensional map view associated with the specific geographic location of the first user profile.

In addition, the system may include a search module of the geo-spatial environment to generate search criteria (e.g., may include a geographic region, a type of accommodation (e.g., may be house, room, apartment, office suite, and/or office, etc.), a rate range, an availability status, a special offer and discounts, an other services availability, and/or a term lease option, etc.), enable selection of at least one search criterion, and to identify and display residential space identifiers matching the search criterion. The system may also include a reservation module of the geo-spatial environment to generate a reservation. Furthermore, the system may include an online payment module to generate an online payment transaction associated with the reservation.

The system may further include an attraction module of the geo-spatial environment to generate and display attraction identifiers, each attraction identifier associated with an attraction in a geographic proximity to a specific geographic location associated with a user profile. Moreover, the system may include a wiki profile module of the geo-spatial environment to generate in the display view, a wiki profile associated with the user profile. The system may also include an append module of the geo-spatial environment to generate, with at least one wiki profile, content (e.g., may include at least one review associated with the first residential space identifier) associated with the wiki profile. In addition, the system may include a view module to generate at least one view of an accommodation associated with the first residential space identifier.

In yet another aspect, a geo-spatial environment includes a first instruction set to enable a community network, to include a map database associated with map data, a user database associated with user profiles, each user profile associated with a specific geographic location identifiable in the map data, and a residential space identifier database associated with residential space identifiers, each residential space identifier associated with a user profile, a second instruction set integrated with the first instruction set to select a first residential space identifier associated with a first user profile, and a third instruction set integrated with the first instruction set and the second instruction set to display a three-dimensional map view embodied by the community network, the first user profile (e.g., the first user profile may be displayed at a location in the three-dimensional map view associated with the specific geographic location of the first user profile), the first residential space identifier, and simultaneously to represent other user profiles adjacent to the first user profile in the three-dimensional map view.

In addition, the geo-spatial environment may include a fourth instruction set to generate search criteria, to enable a selection of at least one search criterion, and to identify and display, in the three-dimension map view, at least one residential space identifier matching the search criterion. The geo-spatial environment may also include a fifth instruction set to generate a reservation associated with an accommodation and the first residential space identifier.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geo-spatial environment communicating with users through a network, according to one embodiment.

FIG. 2 is an exploded view of the community network module of FIG. 1, according to one embodiment.

FIG. 3 is an exploded view of the additional modules of FIG. 1, according to one embodiment.

FIG. 4 is a block diagram illustrating generation of a display view associated with reservations and payment transactions through search criteria, according to one embodiment.

FIG. 5 is a classification view of the search criteria of FIG. 4, according to one embodiment.

FIG. 6 is a user interface view of a user profile, according to one embodiment.

FIG. 7 is a user interface view of searching for residential space identifiers, according to one embodiment.

FIG. 8 is a user interface view of matching the residential space identifiers, according to one embodiment.

FIG. 9 is a user interface view of booking an online reservation based on the type of accommodations, according to one embodiment.

FIG. 10 is a user interface view of making online payment associated with reservations based on the type of accommodations, according to one embodiment.

FIG. 11 is a table view of information associated with availability of reservations based on type of accommodations, according to one embodiment.

FIG. 12 is a diagrammatic system view of a data processing system in which any of the embodiments disclosed herein may be performed, according to one embodiment.

FIG. 13A is a process flow of generating residential space identifiers of FIG. 2 associated with user profiles in a geo-spatial environment, according to one embodiment.

FIG. 13B is a continuation of the process flow of FIG. 13A illustrating additional processes, according to one embodiment.

FIG. 13C is a continuation of the process flow of FIG. 13B illustrating additional processes, according to one embodiment.

Other features of the present embodiments will be apparent from the accompanying drawings and from the detailed description that follows.

### DETAILED DESCRIPTION

A method, apparatus and system of short term residential spaces in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

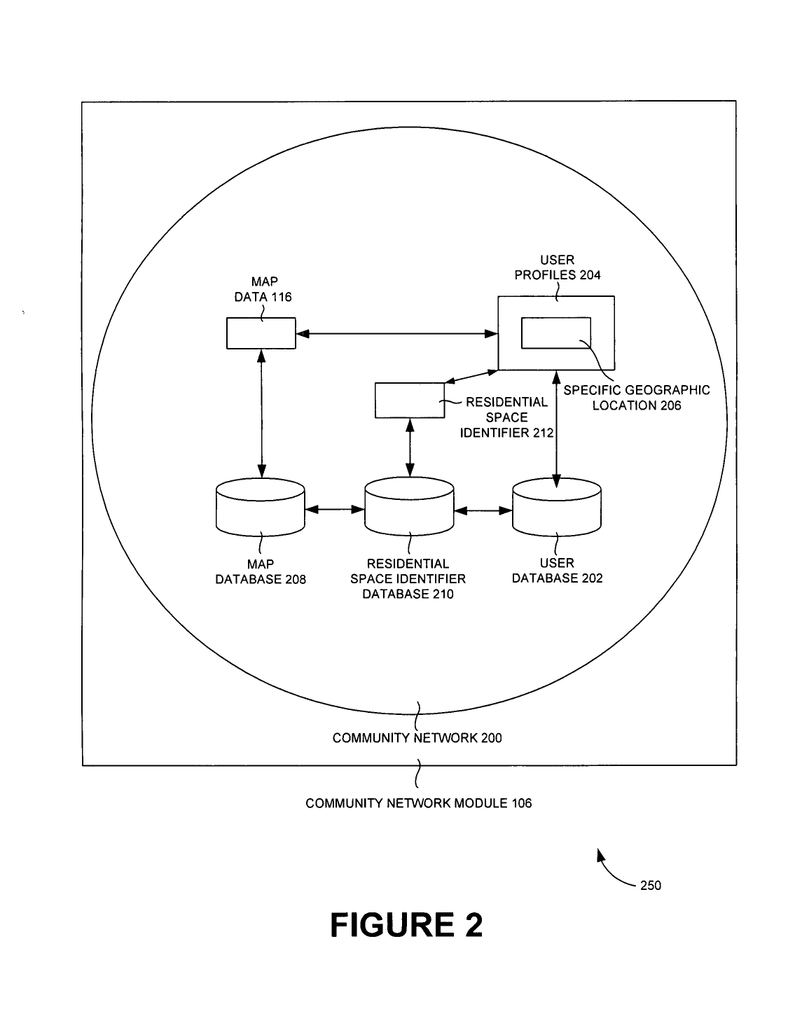

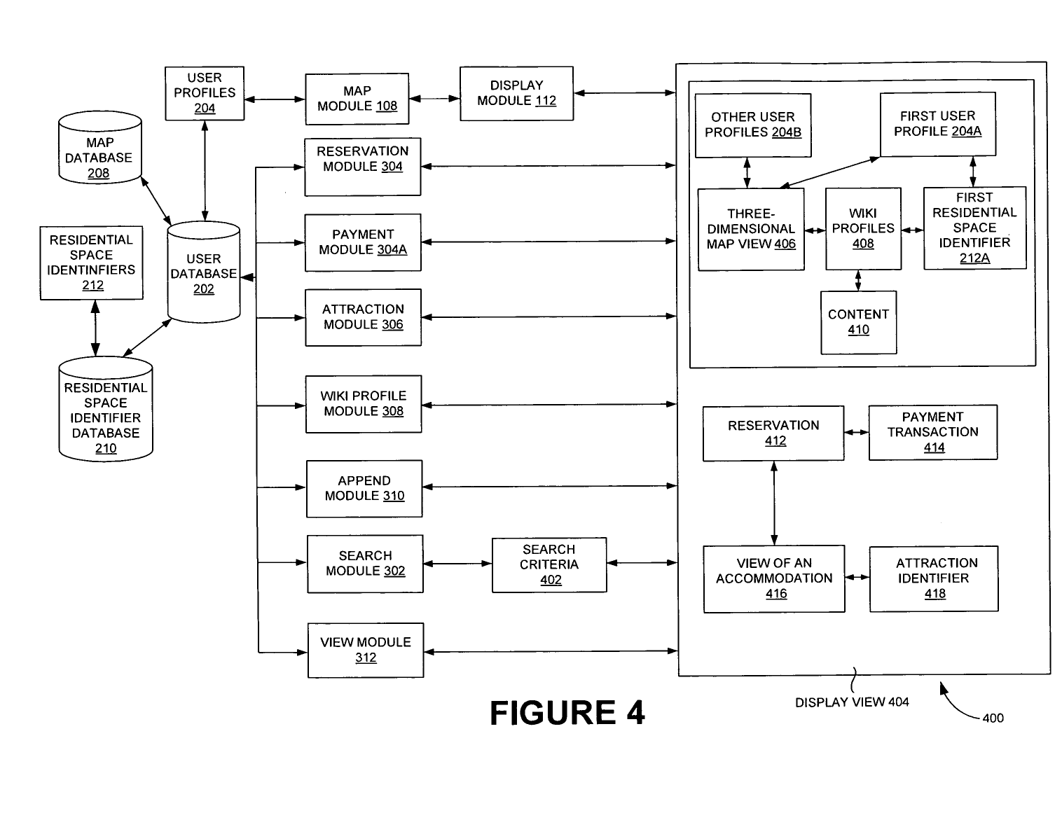

In one embodiment, a method includes generating a community network (e.g., the community network 200 of FIG. 2) of user profiles (e.g., the user profiles 204 of FIG. 2), each user profile 204 associated with a specific geographic location (e.g., the specific geographic location 206 of FIG. 2), generating a first residential space identifier (e.g., the first residential space identifier 212A of FIG. 4) associated with a first user profile (e.g., the first user profile 204A of FIG. 4), and generating a first display view to include a three-dimensional map view (e.g., the three-dimensional map view 406 of FIG. 4) embodied by the community network 200, the first residential space identifier 212A, and the first user profile 204A represented at a location in the three-dimensional map view 406 associated with the specific geographic location 206 of the first user profile 204A.

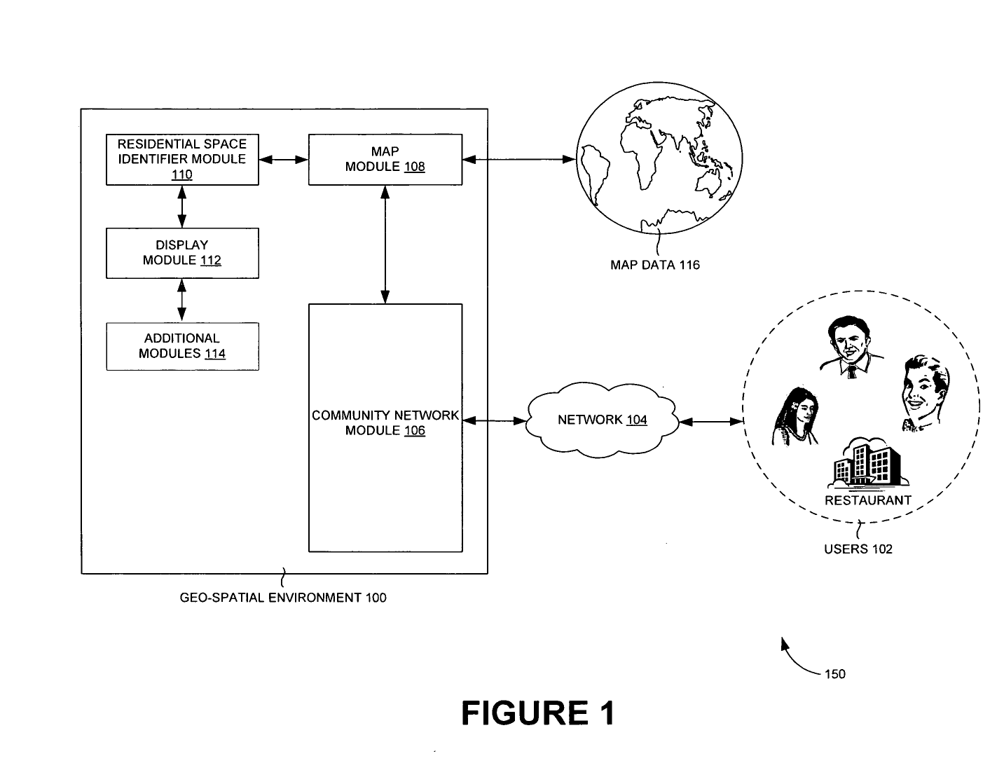

In another embodiment, a system includes a geo-spatial environment (e.g., the geo-spatial environment 100 of FIG. 1), a community network module (e.g., the community network module 106 of FIG. 1) of the geo-spatial environment 100, to include user profiles 204, each user profile 204 to include a specific geographic location (e.g., the specific geographic location 206 of FIG. 2), a residential space identifier module (e.g., the residential space identifier 212 of FIG. 2) of the geo-spatial environment 100 to generate residential space identifiers 212 associated with accommodations, each residential space identifier 212 associated with a user profile (e.g., the user profiles 204 of FIG. 2), a map module (e.g., the map module 108 of FIG. 1) of the geo-spatial environment 100 to include map data (e.g., the map data 116 of FIG. 1) which serve as a basis to render a three-dimensional map view (e.g., the three-dimensional map view 406 of FIG. 4) in the geo-spatial environment 100 which identifies at least some physical structures having specific geographic locations (e.g., the specific geographic location 206 of FIG. 2), and a display module (e.g., the display module 112 of FIG. 1) of the geo-spatial environment 100 to generate a display view (e.g., the display view 404 of FIG. 4) of the three-dimensional map view 406 embodied by the community network 200, a first user profile (e.g., the first user profile 204A of FIG. 4), and a first residential space identifier (e.g., the first residential space identifier 212A of FIG. 4) associated with the first user profile 204A represented at a location in the three-dimensional map view 406 associated with the specific geographic location 206 of the first user profile 204A.

In yet another embodiment, a geo-spatial environment (e.g., the geo-spatial environment 100 of FIG. 1) includes a first instruction set to enable a community network (e.g., the community network 200 of FIG. 2), to include a map database (e.g., the map database 208 of FIG. 2) associated with map data (e.g., the map data 116 of FIG. 1), a user database (e.g., the user database 202 of FIG. 2) associated with user profiles (e.g., the user profiles 204 of FIG. 2), each user profile 204 associated with a specific geographic location (e.g., the specific geographic location 206 of FIG. 2) identifiable in the map data 116, and a residential space identifier database (e.g., the residential space identifier database 210 of FIG. 2) associated with residential space identifiers (e.g., the residential space identifier 212 of FIG. 2), each residential space identifier 212 associated with a user profile (e.g., the user profile 204 of FIG. 2), a second instruction set integrated with the first instruction set to select a first residential space identifier (e.g., first residential space identifier 212A of FIG. 4) associated with a first user profile (e.g., the first user profile 204A of FIG. 4), and a third instruction set integrated with the first instruction set and the second instruction set to display a three-dimensional map view (e.g., the three-dimensional map view 406 of FIG. 4) embodied by the community network 200, the first user profile 204A, the first residential space identifier 212A, and simultaneously to represent other user profiles (e.g., the other user profiles 204B of FIG. 4) adjacent to the first user profile 204A in the three-dimensional map view 406, wherein the first user profile 204A is displayed at a location in the three-dimensional map view 406 associated with the specific geographic location 206 of the first user profile 204A.

FIG. 1 is a system view 150 of a geo-spatial environment 100 communicating with users 102 through a network 104, according to one embodiment. Particularly, FIG. 1 illustrates the geo-spatial environment 100, the users 102, the network 104, a community network module 106, a map module 108, a residential space identifier module 110, a display module 112, additional modules 114, and map data 116, according to one embodiment.

The geo-spatial environment 100 may enable the users 102 to search for residential space (e.g., house, room, apartment, office suite, and/or office, etc.). The users 102 may be registered and/or unregistered users communicating with each other. The network 104 may enable communication between the users 102 and the geo-spatial environment 100. The community network module 106 may generate a community network (e.g., the community network 200 of FIG. 2) of user profiles (e.g., the user profiles 204 of FIG. 2) associated with specific geographic locations (e.g., the specific geographic location 206 of FIG. 2) in the geo-spatial environment 100.

The map module 108 may generate a three-dimensional map view (e.g., the three-dimensional map view 406 of FIG. 4) that renders specific geographic locations (e.g., the specific geographic location 206 of FIG. 2) of the user profiles 204 (e.g., the location of the users may be associated with the first user profile 204A and other user profiles 204B) using the map data 116 in the geo-spatial environment 100. The residential space identifier module 110 may generate residential space identifiers for accommodations in the geo-spatial environment 100. The display module 112 may generate a display view (e.g., the display view 404 of FIG. 4) which includes the three-dimensional map view 406 embodied by the community network 200 in the geo-spatial environment 100.

The additional modules 114 may include other modules that generate additional processes associated with the community network 200. The map data 116 may contain details of maps of any region, area and/or neighborhood in the geo-spatial environment 100 which serves as a basis to identify physical structures (e.g., residences, and/or civic structures, etc.) having specific geographic locations (e.g., the specific geographic location 206 of FIG. 2) in the three-dimensional map view 406.

In the example embodiment illustrated in FIG. 1, the users 102 communicate with the geo-spatial environment 100 through the network 104. The geo-spatial environment 100 consists of the community network module 106, the map module 108, the residential space identifier module 110, the display module 112, and the additional modules 114 communicating with each other. In addition, the map module 108 communicates with the map data 116.

The community network module 106 of the geo-spatial environment 100 may include user profiles (e.g., the user profiles 204 of FIG. 2), each user profile 204 to include a specific geographic location (e.g., the specific geographic location 206 of FIG. 2). The map module 108 of the geo-spatial environment 100 may include map data 116 which serve as a basis to render the three-dimensional map view 406 in the geo-spatial environment 100 which identifies some physical structures having specific geographic locations 206.

The residential space identifier module 110 of the geo-spatial environment 100 may generate residential space identifiers 212 associated with accommodations, each residential space identifier 212 associated with the user profile 204. The display module 112 of the geo-spatial environment 100 may generate the display view 404 of the three-dimensional map view 406 embodied by the community network 200, a first user profile (e.g., the first user profile 204A of FIG. 4), and a first residential space identifier (e.g., the first residential space identifier 212A of FIG. 4) associated with the first user profile 204A represented at a location in the three-dimensional map view 406 associated with the specific geographic location 206 of the first user profile 204A.

FIG. 2 is an exploded view 250 of the community network module 106 of FIG. 1, according to one embodiment. Particularly, FIG. 2 illustrates a community network 200, a user database 202, user profiles 204, a specific geographic location 206, a map database 208, a residential space identifier database 210, and a residential space identifier 212, according to one embodiment.

The community network 200 may be a network of people, places and/or businesses in the geo-spatial environment 100 associated with the user profiles 204 having the specific geographic location 206. The user database 202 may contain user profiles 204 associated with the specific geographic location 206 in the community network 200. The user profiles 204 may refer to the user profiles (e.g., containing age data, interest data, occupation data, etc.) of the users 102 which are associated with the specific geographic location 206 involved in the communication.

The specific geographic location 206 may refer to the specific location of the users 102 associated with the user profile 204. The map database 208 may contain the map data 116 of any area, region and/or neighborhood of the users 102 associated with the user profiles 204. The residential space identifier database 210 may contain the residential space identifiers 212, each of the residential space identifier 212 associated with the user profile 204.

In the example embodiment illustrated in FIG. 2, the community network module 106 includes the community network 200 containing the user database 202, the map database 208 and the residential space identifier database 210 communicating with each other. In addition, the user database includes the user profiles 204, and the specific geographic location 206. The map database 208 includes the map data 116. The residential space identifier database 210 includes the residential space identifier 212.

A first instruction set of the geo-spatial environment 100 may enable the community network 200 to include the map database 208 associated with the map data 116, the user database 202 associated with user profiles 204, each user profile 204 associated with the specific geographic location 206 identifiable in the map data 116, and the residential space identifier database 210 associated with the residential space identifiers 212, each residential space identifier 212 associated with the user profile 204. The community network 200 of the user profiles 204 may be generated, each user profile 204 associated with the specific geographic location 206.

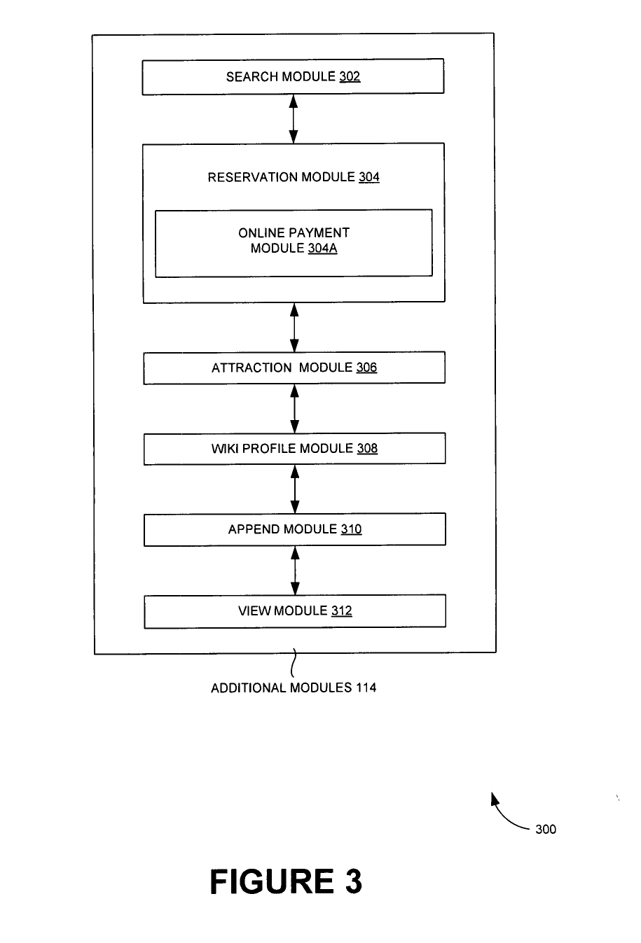

FIG. 3 is an exploded view 300 of the additional modules 114 of FIG. 1, according to one embodiment. Particularly, FIG. 3 illustrates a search module 302, a reservation module 304, an online payment module 304A, an attraction module 306, a wiki profile module 308, a append module 310, and a view module 312, according to one embodiment.

The search module 302 may generate search criteria for the users 102 to perform a search of the residential space identifiers 212 and/or based on criteria in the geo-spatial environment 100. The reservation module 304 may generate online reservations and/or provide reservation information associated with type of accommodations. The online payment module 304A may generate online payment transactions associated with the reservation information of the type of accommodations. The attraction module 306 may generate attraction identifiers (e.g., the attraction identifier 418 of FIG. 4) in the vicinity of the specific geographic location 206 associated with the user profile 204.

The wiki profile module 308 may generate wiki profiles (e.g., the wiki profiles 408 of FIG. 4) associated with the user profiles 204 in the display view 404. The append module 310 may generate content (e.g., comments, feedback, remarks, etc.) associated with the wiki profiles 408 by the users 102 of the geo-spatial environment 100. The view module 312 may generate views of accommodations (e.g., the view of an accommodation 416 of FIG. 4) associated with the first residential space identifier 212A which is associated with the first user profile 204A.

In the example embodiment illustrated in FIG. 3, the additional modules 114 include the search module 302, the reservation module 304, the attraction module 306, the wiki profile module 308, the append module 310, and the view module 312 communicating with each other. In addition, the reservation module 304 includes the online payment module 304A.

The search module 302 of the geo-spatial environment 100 may generate search criteria (e.g., the search criteria 402 of FIG. 4), enable selection of at least one search criterion of the search criteria 402, and to identify and display residential space identifiers 212 matching the search criterion of the search criteria 402. The reservation module 304 of the geo-spatial environment 100 may generate a reservation. The online payment module 304A may generate an online payment transaction associated with the reservation. The attraction module 306 of the geo-spatial environment 100 may generate and display the attraction identifiers 418, each attraction identifier associated with an attraction (e.g., museums, amusement parks, national parks, and/or monuments, etc.) in a geographic proximity to the specific geographic location 206 associated with the user profile 204.

The wiki profile module 308 of the geo-spatial environment 100 may generate in the display view 404, the wiki profile 408 associated with the user profile 204. The append module 310 of the geo-spatial environment 100 may generate, with at least one wiki profile 408, content 410 associated with the wiki profile 408. The view module 312 may generate at least one view of an accommodation associated with the first residential space identifier 212A.

FIG. 4 is a block diagram 400 illustrating generation of a display view 404 associated with reservations and payment transactions through a search criteria 402, according to one embodiment. Particularly, FIG. 4 illustrates the search criteria 402, the display view 404, a three-dimensional map view 406, wiki profiles 408, content 410, a reservation 412, a payment transaction 414, a view of accommodation 416, and an attraction identifier, according to one embodiment.

The search criteria 402 may serve as a markup page tool (e.g., search engines) on which the users 102 search for desired type of accommodations based on the residential space identifier 212 associated with the user profiles 204. The display view 404 may display the user profiles 204, the wiki profiles 408, the content 410 associated with the wiki profiles 408 and/or the payment transaction information associated with the reservation status. The three-dimensional map view 406 may enable the users 102 to visualize the user profiles 204, type of accommodations, rate range, term lease options, and/or the availability status, etc.

The wiki profiles 408 may be the profiles associated with the users 102 that are displayed in the three-dimensional map view 406. The content 410 may provide information of the users 102 associated with the wiki profiles 408 in the geo-spatial environment 100. The reservation 412 may enable the users 102 to visualize the status of availability of type of accommodations and/or make online reservations. The payment transaction 414 may enable the users 102 to make the online payment transactions associated with the reservations. The view of an accommodation 416 may enable the users 102 to view type of accommodations (e.g., house, room, apartment, office suite, and/or office, etc.) based on the search criteria 402. The attraction identifier 418 may be associated with an attraction in a geographic proximity which enables the users 102 (e.g., accommodation providers) to attract with the type of accommodations of the specific geographic location 206 associated with the user profiles 204.

In the example embodiment illustrated in FIG. 4, the display view includes the three-dimensional map view 406, the wiki profiles 408 generated from the wiki profile module 308 and the content 410 generated from the append module 310. The display view also displays the first user profile 204A, other user profiles 204B (e.g., from the user database 202 of FIG. 2), and the first residential space identifier 212A associated with the first user profile 204A. In addition, the display view 404 also includes the reservation 412 (e.g. reservation status), and the payment transaction 414 associated with the reservation 412. The users 102 may also view an accommodation using the accommodation option 416 and/or the attraction identifier 418 (e.g., based on the search criteria).

The first residential space identifier 212A associated with the first user profile 204A may be generated and/or the first display view may be generated to include the three-dimensional map view 406 embodied by the community network 200, the first residential space identifier 212A, and the first user profile 204A represented at a location in the three-dimensional map view 406 associated with the specific geographic location 206 of the first user profile 204. Other user profiles 204B may be represented simultaneously adjacent to the first user profile 204A in the three-dimensional map view 406. The residential space identifiers 212 may be generated, each residential space identifier 212 associated with the user profile 204.

The search of the residential space identifiers 212 may be generated based on at least one criterion. The residential space identifier 212 matching the criterion may be identified. A second display view may be generated to include the three-dimensional map view 406 embodied by the community network 200, the residential space identifier 212, and a second user profile associated with the at least one residential space identifier 212 represented at a location in the three-dimensional map view 406 associated with the specific geographic location 206 associated with the second user profile. The reservation information may be displayed in the first display view. An online reservation and a financial transaction associated with the first residential space identifier 212A may be generated.

The first residential space identifier 212 may be associated with at least one type of accommodation associated with the specific geographic location 206 of the first user profile 204A. A visual representation associated with the accommodation may be generated and the visual representation associated with the first residential space identifier 212 may be displayed. The wiki profile 408 associated with the first user profile 204A may be generated. The wiki profile 408 associated with the first user profile 204A may be displayed. The content 410 associated with the wiki profile 408 may be generated. The content 410 associated with the wiki profile 408 may be displayed (e.g., using the display module 112 of FIG. 1).

The content 410 may include at least one review associated with the first residential space identifier 212A. The geo-spatial environment 100 may include a second instruction set integrated with the first instruction set to select the first residential space identifier 212A associated with the first user profile 204A. A third instruction set integrated with the first instruction set and the second instruction set may display the three-dimensional map view 406 embodied by the community network 200, the first user profile 204A, the first residential space identifier 212A, and simultaneously represent other user profiles 204B adjacent to the first user profile 204A (e.g., may be displayed at a location in the three-dimensional map view 406 associated with the specific geographic location 206 of the first user profile 204A) in the three-dimensional map view 406.

A fourth instruction set may generate the search criteria 402, to enable a selection of at least one search criterion of the search criteria 402, and identify and display in the three-dimensional map view 406 at least one residential space identifier 212 matching the search criterion of the search criteria 402. A fifth instruction set may generate a reservation associated with an accommodation and the first residential space identifier 212A.

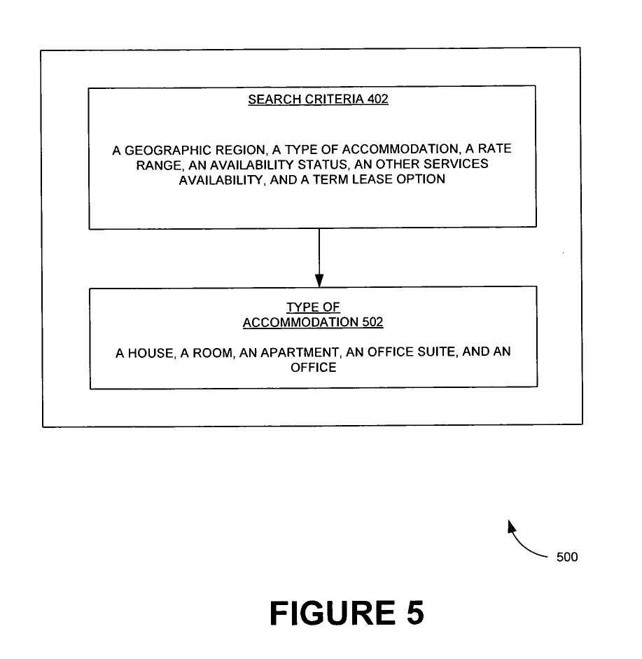

FIG. 5 is a classification view 500 of the search criteria 402 of FIG. 4, according to one embodiment. Particularly, FIG. 5 illustrates the search criteria 402, and a type of accommodation 502, according to one embodiment. The type of accommodation 502 may enable the users 102 to search for an accommodation (e.g., house, room, apartment, office suite, and/or office etc.) through the markup page tool (e.g., using search engines). For example, a user may wish to travel from Palo Alto, Calif. to New York City, N.Y., and desire short-term accommodation facilities upon arrival in New York. The user may search (e.g., using the search engine) for such facilities based on any number of criteria (e.g., a geographic region, a type of accommodation, a rate range, an availability status, an other services availability, and/or a term lease option, etc. The user may also select a preferred type of accommodation 502, based on his/her lodging and/or ambience preferences, as illustrated in FIG. 5.

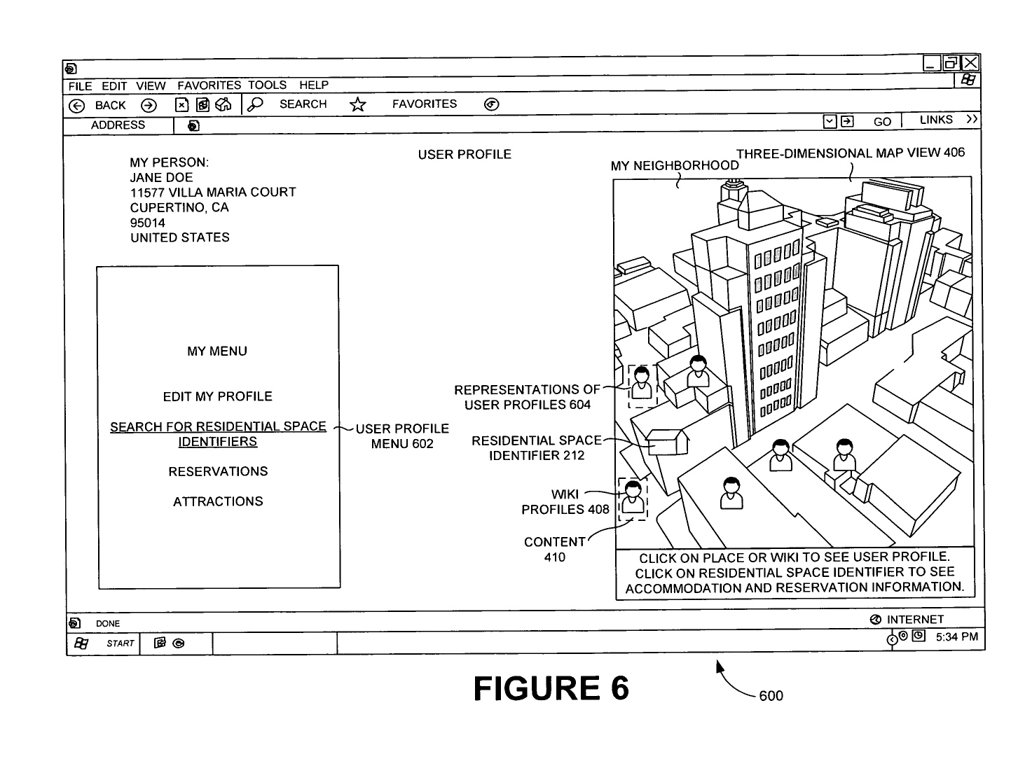

FIG. 6 is a user interface view 600 of a user profile 204, according to one embodiment. Particularly, FIG. 6 illustrates the residential space identifier 212, the three-dimensional map view 406, the wiki profiles 408, the content 410, a user profile menu option 602, and representations of user profiles 604, according to one embodiment. The user profile menu option 602 may enable the users 102 to view, edit their profiles. The representations of user profiles 604 may display the profiles associated with the users 102 on the three-dimensional map view 406.

In the example embodiment illustrated in FIG. 6, the user interface view 600 may enable the users 102 to edit their profiles. For example, Jane Doe having a residential address in United States (e.g., 11577, Villa Maria Court, Cupertino, Calif., 95014) may edit her profile. In addition, Jane Doe may also search for the residential space identifiers 212 (e.g., by using the search module 302 of FIG. 3) and/or make reservations for the type of accommodation she is interested in. The user interface view 600 also displays the residential space identifier 212, the wiki profiles 408, the content 410 associated with the wiki profiles 408, the representations of user profiles 604. In addition, the users 102 may click on links leading to places or wikis to see user profiles 204 and/or click on residential space identifiers link to see accommodation and reservation information.

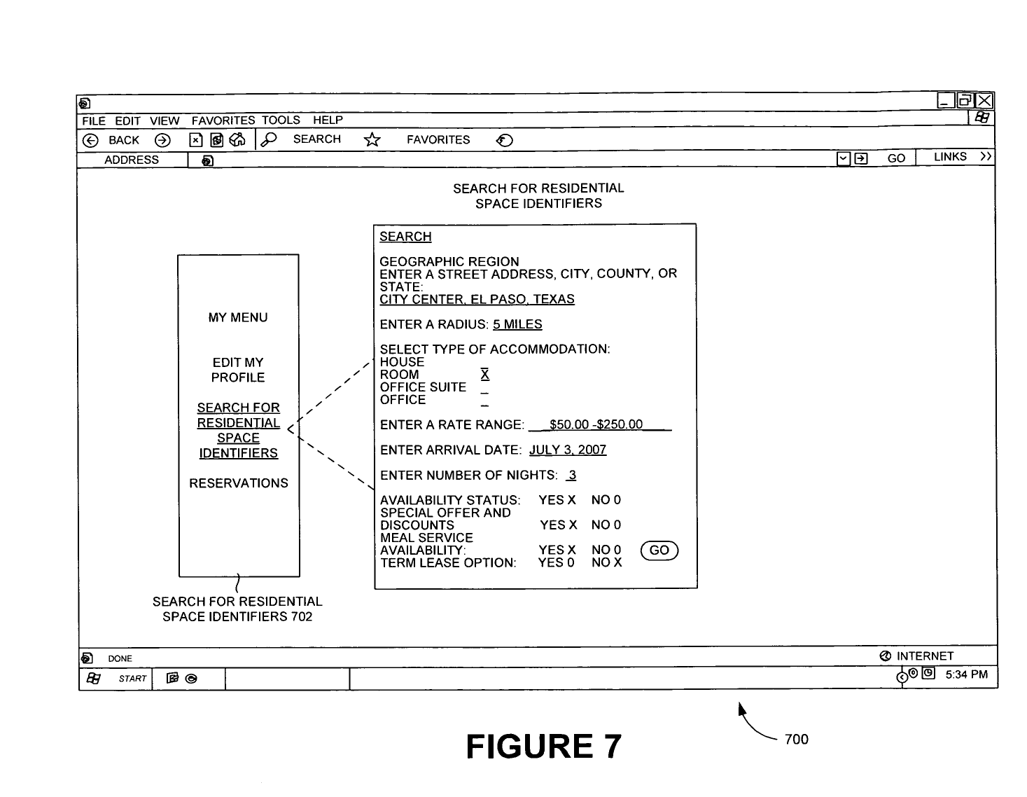

FIG. 7 is a user interface view 700 of searching for residential space identifiers 212, according to one embodiment. Particularly, FIG. 7 illustrates a search for residential space identifiers option 702, according to one embodiment. The search for residential space identifiers option 702 may enable the users 102 to search for the residential space identifiers 212 for reservations in a geographic region.

In the example embodiment illustrated in FIG. 7, the user interface view 700 may enable the users 102 to edit their profiles and/or search for the residential space identifiers within a threshold radius (e.g., 5 miles around a location) for reservations. For example, Jane Doe may search for the residential space identifiers 212 in the geographic region by entering street address, city, county and/or state. In addition, Jane Doe may also select the type of accommodation (e.g., house, room, apartment, office suite, and/or office, etc.) by entering a rate range per night (e.g., $50.00-$250.00), arrival date (e.g., Jul. 3, 2007) and number of nights stay (e.g., 3 nights) and/or check for the availability status (e.g., “Yes” if available, “No” if not available), special offer and discounts, and other services availability (e.g., meals, swimming pool, gymnasium, etc.) by clicking on the link “GO”. The user interface view 700 may also enable the users 102 (e.g., Jane Doe) to check for term lease, if applicable to any of the type of accommodations.

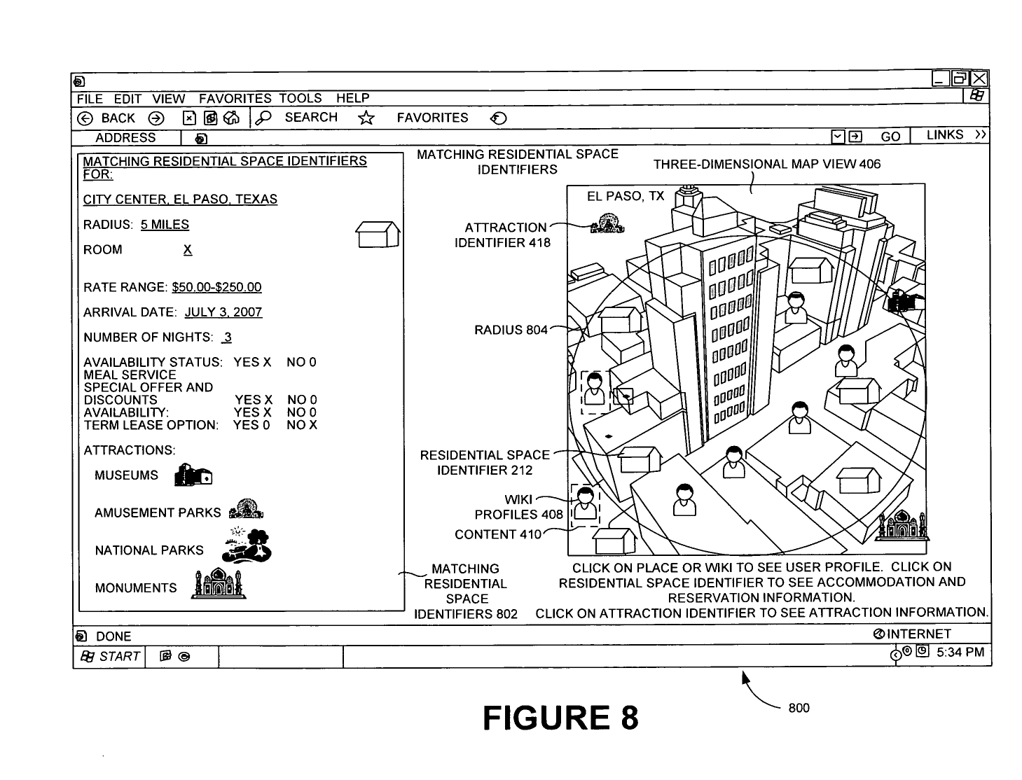

FIG. 8 is a user interface view 800 of matching the residential space identifiers 212, according to one embodiment. Particularly, FIG. 8 illustrates the residential space identifier 212, the three-dimensional map view 406, the wiki profiles 408, the content 410, the attraction identifier 418, a matching residential space identifier menu 802, and a radius field 804, according to one embodiment. The matching residential space identifier menu 802 may enable the users 102 to match the residential space identifiers 212 for a particular geographic region. The radius field 804 may enable the users 102 to select the residential space identifiers located within a threshold radius away from the user 102.

In the example embodiment illustrated in FIG. 8, the user interface view 800 may enable the users 102 to match residential space identifiers 212 located within the threshold radius (e.g., 5 miles away from the location). For example, Jane Doe may match for a room (e.g., located at City Center, El Paso, Tex., 5 miles away from the location) based on the rate range per night (e.g., $50.00-$250.00), arrival date (e.g., Jul. 3, 2007) and number of nights stay (e.g., 3 nights) and/or check for the availability status (e.g., “Yes” if available, “No” if not available), special offer and discounts, and other services availability (e.g., meals, swimming pool, gymnasium, etc.).

In addition, Jane Doe may also be interested in the attraction identifiers 418 (e.g., museums, amusement parks, national parks, and/or monuments, etc.). The user interface view 800 may enable the users 102 (e.g., Jane Doe) to see attraction information by clicking on the click on attraction identifier link to see attraction information link on the three-dimensional map view 406.

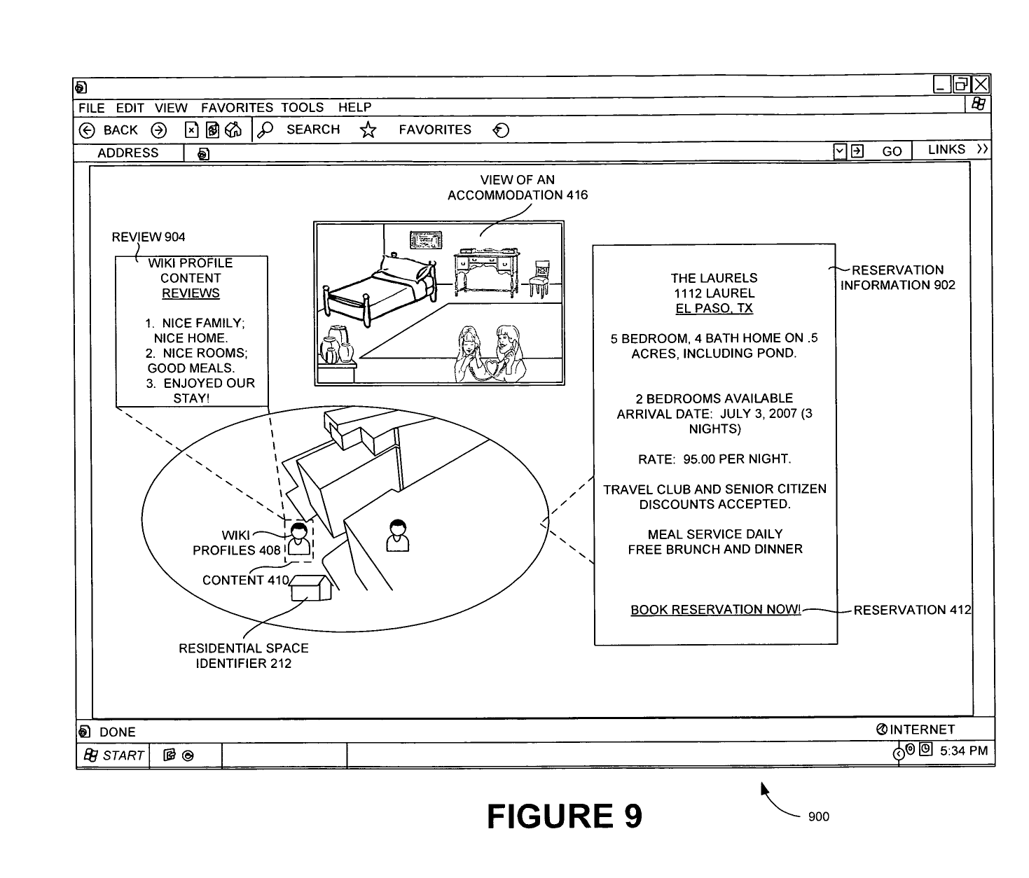

FIG. 9 is a user interface view 900 of booking an online reservation based on the type of accommodations, according to one embodiment. Particularly, FIG. 9 illustrates the residential space identifier 212, the wiki profiles 408, the content 410, the view of an accommodation 416, reservation information field 902, and a review 904, according to one embodiment. The reservation information field 902 may enable the users 102 to view the information related to reservation for the type of accommodations. The review 904 may enable the users 102 to view the wiki profiles contents reviews associated with the user profiles 204.

In the example embodiment illustrated in FIG. 9, the user interface view 900 may enable the users 102 to book reservations and/or get reservation information for the accommodation through the book reservation now link. For example, Jane Doe may book a house (e.g., The Laurels, located at 1112, Laurel, El Paso, Tex.). Jane Doe may also book rooms based on their availability (e.g., 2 bedrooms available), and/or rate range (e.g., $95.00 per night). In addition, Jane Doe may also avail discounts on travel club and for senior citizenship and/or free meals and/or dinners services. The user interface view 900 may also enable the users 102 to view the wiki profile content reviews (e.g., nice family, nice home, nice rooms, good meal, enjoyed our stay, etc.).

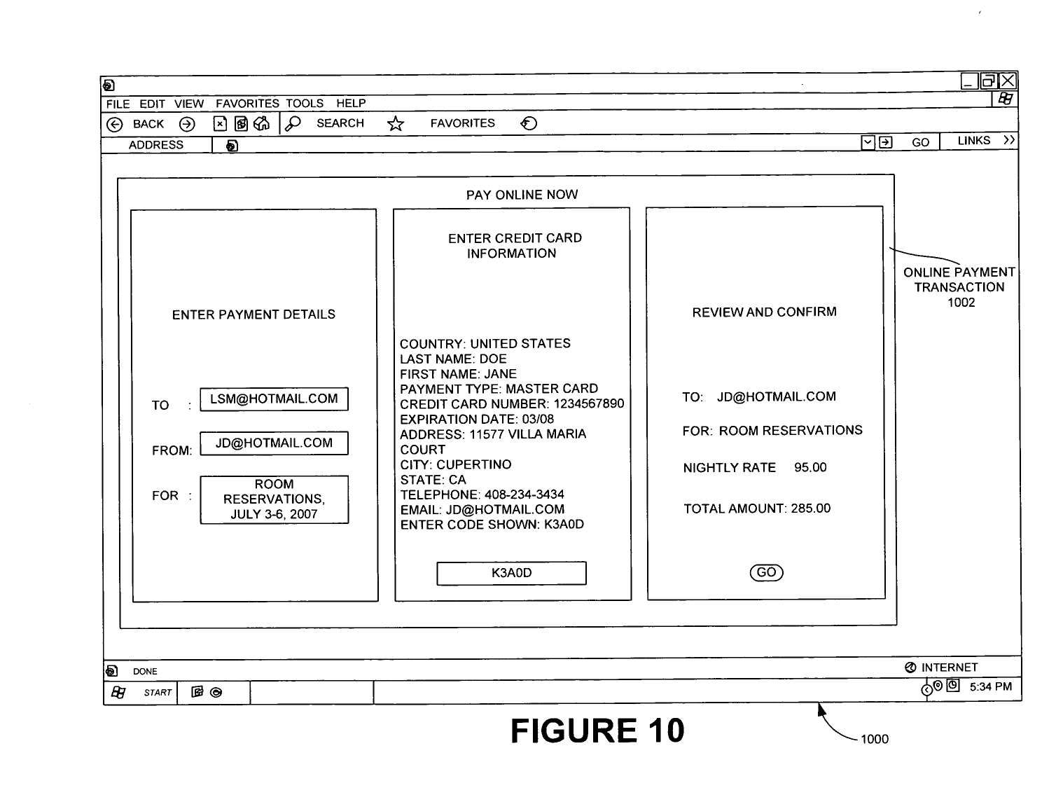

FIG. 10 is a user interface view 1000 of making online payments associated with reservations based on the type of accommodations, according to one embodiment. Particularly, FIG. 10 illustrates an online payment transaction menu option 1002, according to one embodiment. The online payment transaction menu option 1002 may enable the users to make online payments related to reservations.

In the example embodiment illustrated in FIG. 10, the user interface view 1000 may enable the users 102 to enter payment details for the transaction to be made by a user email-ID (e.g., jd@hotmail.com) to provider (e.g., lsm@hotmail.com) for accommodations (e.g., house, room, apartment, office suite, office, etc.). The user interface view 1000 may enable the users 102 to enter credit card information (e.g., Country: United States, Last Name: Doe, First Name: Jane, Payment Type: Master Card, Credit Card Number: 1234567890, Expiration Date: 03/08, Address: 11577, Villa Maria Court, City: Cupertino, State: CA, Telephone: 408-234-3434, Email: jd@hotmail.com, etc.) related to payment of reservations for accommodations and confirm the details entered by entering a code shown (e.g., “K3AOD)”. In addition, the user interface view 1000 may enable the users 102 to preview and confirm the payments made (e.g., nightly rates: $95.00, total amount: $285.00) associated with the reservations for accommodations.

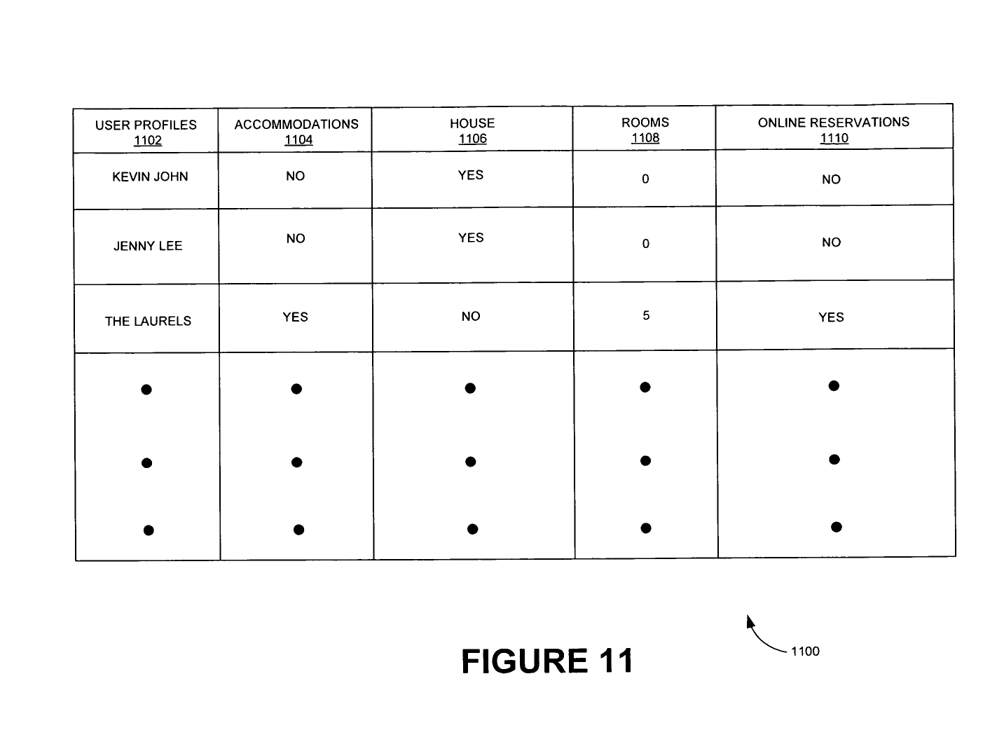

FIG. 11 is a table view 1100 of information associated with reservations based on type of accommodations, according to one embodiment. Particularly, FIG. 11 illustrates a user profiles field 1102, an accommodations field 1104, a house field 1106, a rooms field 1108, and an online reservations field 1110, according to one embodiment.

The user profiles field 1102 may display the profiles of the users 102 associated with the reservations for the accommodations. The accommodations field 1104 may display the status of availability of accommodations for the users 102. The house field 1106 may display the type of accommodation for the users 102. The rooms field 1108 may display rooms required for accommodation. The online reservations field 1110 may display the status of online booking done by the users 102.

In the example embodiment illustrated in FIG. 11, the user profiles field 1102 displays “Kevin John” in the first row, “Jenny Lee” in the second row, and “The Laurels” in the third row of the user profiles field 1102 column. The accommodations field 1104 displays “No” in the first row, “No” in the second row and “Yes” in the third row of the accommodations field 1104 column (e.g., Kevin John and Jenny Lee do not have accommodations while The Laurels provides accommodation). The house field 1106 displays “Yes” in the first row, “Yes” in the second row and “No” in the third row of the house field 1106 column (e.g., Kevin John and Jenny Lee need a house for accommodation and The Laurels does not provide house for rent). The rooms fields 1108 displays “0” for Kevin John in the first row, “0” for Jenny Lee in the second row and “5” for The Laurels in the third row of the rooms field 1108 column (e.g., Kevin John and Jenny Lee do not need rooms for accommodation, while The Laurels have 5 rooms for providing accommodations). The online reservations field 1110 displays “No” in the first row, “No” in the second row and “Yes” in the third row of the online reservations field 1110 column (e.g., Kevin John and Jenny Lee have not made online reservations and The Laurels provides the facility of online reservations for accommodations).

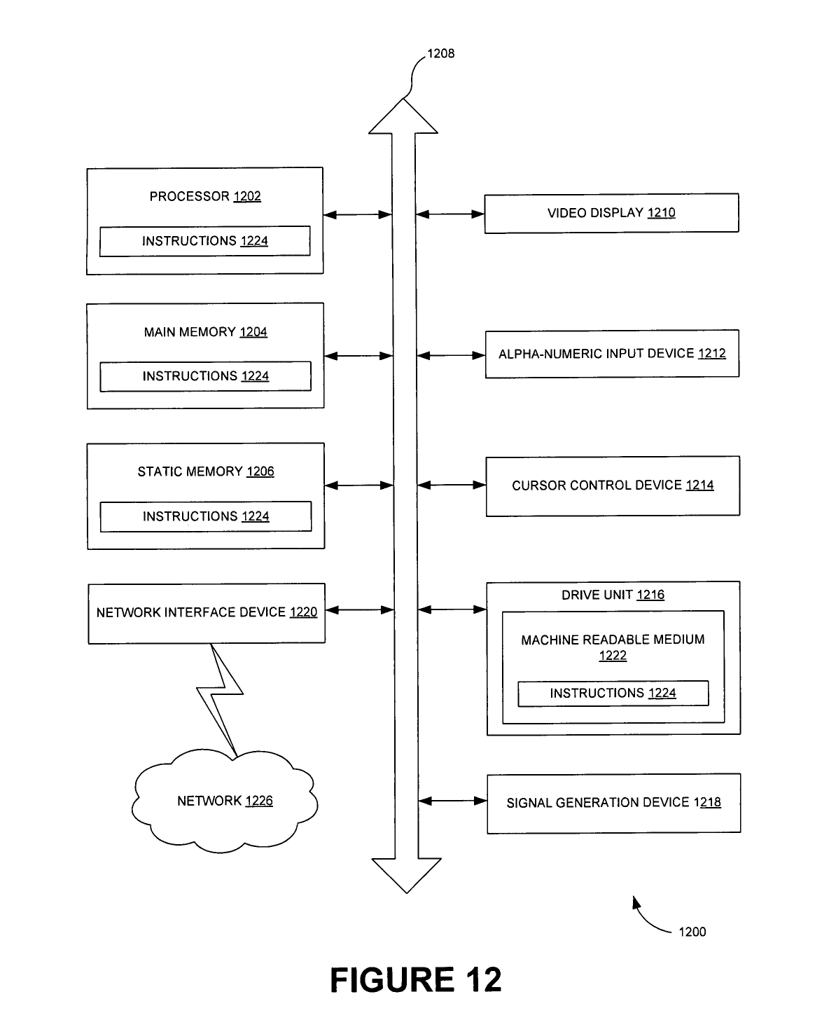

FIG. 12 is a diagrammatic system view 1200 of a data processing system in which any of the embodiments disclosed herein may be performed, according to one embodiment. Particularly, the system view 1200 of FIG. 12 illustrates a processor 1202, a main memory 1204, a static memory 1206, a bus 1208, a video display 1210, an alpha-numeric input device 1212, a cursor control device 1214, a drive unit 1216, a signal generation device 1218, a network interface device 1220, a machine readable medium 1222, instructions 1224, and a network 1226, according to one embodiment.

The diagrammatic system view 1200 may indicate a personal computer and/or a data processing system in which one or more operations disclosed herein may be performed. The processor 1202 may be a microprocessor, a state machine, an application-specific integrated circuit, a field programmable gate array, etc. (e.g., Intel® Pentium® processor). The main memory 1204 may be a dynamic random access memory and/or a primary memory of a computer system. The static memory 1206 may be a hard drive, a flash drive, and/or other memory information associated with the data processing system.

The bus 1208 may be an interconnection between various circuits and/or structures of the data processing system. The video display 1210 may provide graphical representation of information on the data processing system. The alpha-numeric input device 1212 may be a keypad, a keyboard and/or any other input device of text (e.g., a special device to aid the physically challenged). The cursor control device 1214 may be a pointing device such as a mouse.

The drive unit 1216 may be the hard drive, a storage system, and/or other longer term storage subsystem. The signal generation device 1218 may be a bios and/or a functional operating system of the data processing system. The network interface device 1220 may be a device that performs interface functions such as code conversion, protocol conversion and/or buffering required for communication to and from the network 1226. The machine readable medium 1222 may provide instructions on which any of the methods disclosed herein may be performed. The instructions 1224 may provide source code and/or data code to the processor 1202 to enable any one or more operations disclosed herein.

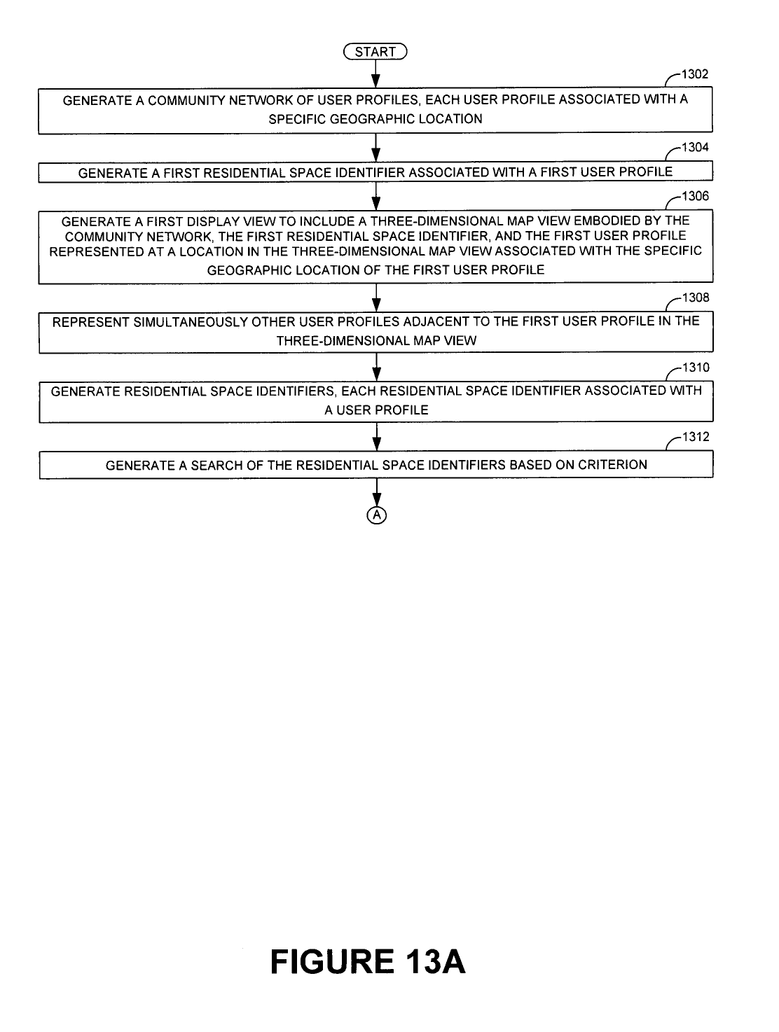

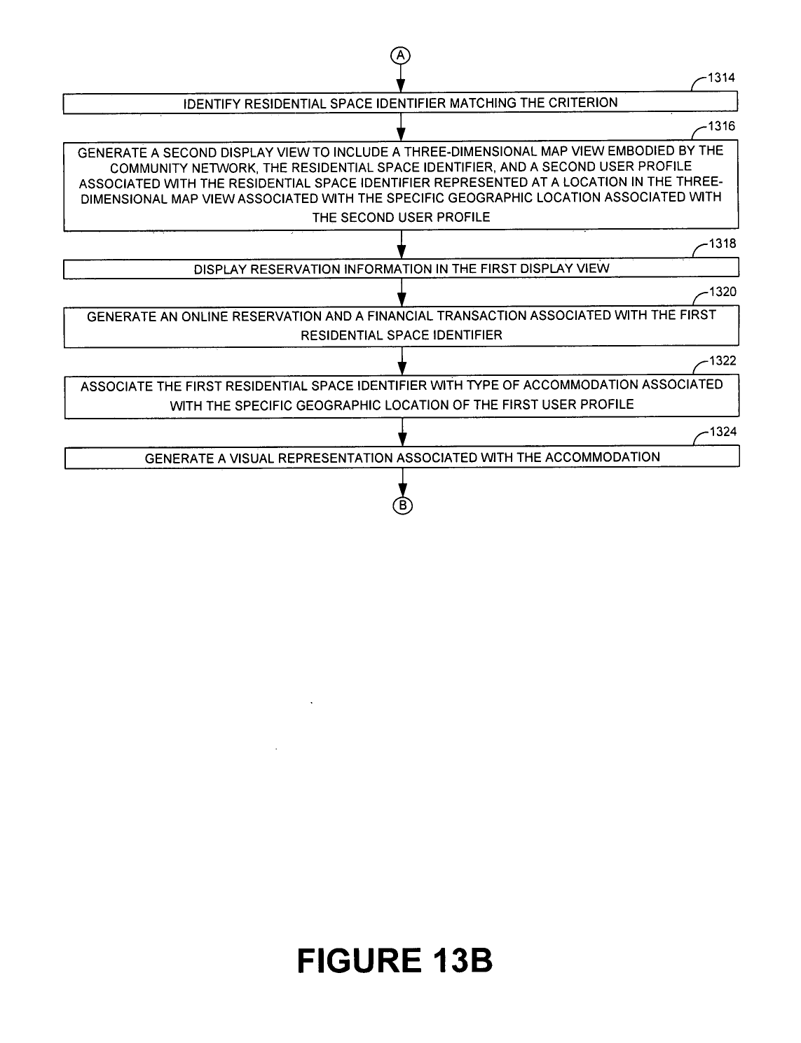

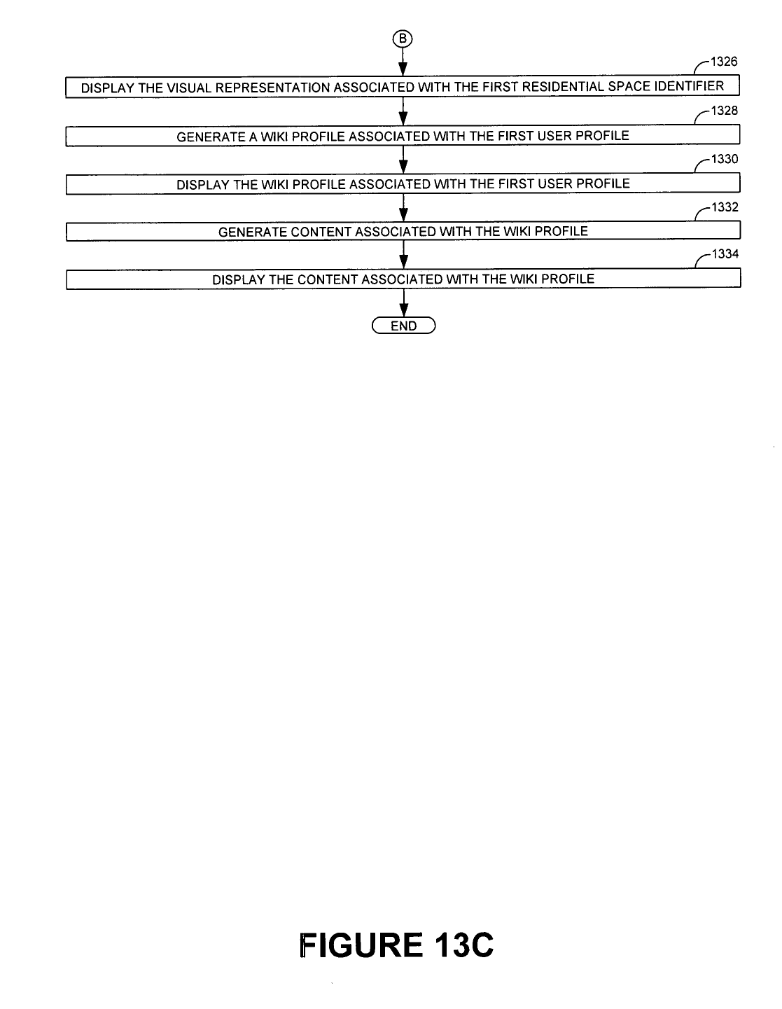

FIG. 13A is a process flow of generating residential space identifiers 212 associated with user profiles 204 in a geo-spatial environment 100, according to one embodiment. In operation 1302, a community network (e.g., the community network 200 of FIG. 2) of user profiles (e.g., the user profiles 204 of FIG. 2) may be generated, each user profile 204 associated with a specific geographic location (e.g., the specific geographic location 206 of FIG. 2). In operation 1304, a first residential space identifier (e.g., the first residential space identifier 212A of FIG. 4) associated with a first user profile (e.g., the first user profile 204A of FIG. 4) may be generated. In operation 1306, a first display view may be generated (e.g., using the display module 112 of FIG. 1) to include a three-dimensional map view (e.g., the three-dimensional map view 406 of FIG. 4) embodied by the community network 200, the first residential space identifier 212A, and the first user profile 204A represented at a location in the three-dimensional map view 406 associated with the specific geographic location 206 of the first user profile 204A. In operation 1308, other user profiles (e.g., the other user profiles 204B of FIG. 4) may be represented simultaneously adjacent to the first user profile 204A in the three-dimensional map view 406. In operation 1310, residential space identifiers (e.g., the residential space identifier 212 of FIG. 2) may be generated, each residential space identifier 212 associated with the user profile 204. In operation 1312, a search of the residential space identifiers 212 may be generated (e.g., using the search module 302 of FIG. 3) based on criterion.

FIG. 13B is a continuation of the process flow of FIG. 13A illustrating additional processes, according to one embodiment. In operation 1314, the residential space identifier 212 matching the criterion may be identified (e.g., using the search criteria 402 of FIG. 4). In operation 1316, a second display view may be generated (e.g., using the display module 112 of FIG. 1) to include a three-dimensional map view (e.g., the three-dimensional map view 406 of FIG. 4) embodied by the community network 200, the residential space identifier 212, and a second user profile associated with the residential space identifier 212 represented at a location in the three-dimensional map view 406 associated with the specific geographic location 206 associated with the second user profile. In operation 1318, reservation information may be displayed (e.g., using the display module 112 of FIG. 1) in the first display view. In operation 1320, an online reservation and/or a financial transaction associated with the first residential space identifier 212 may be generated (e.g., using the reservation module 304 and the online payment module 304A of FIG. 3). In operation 1322, the first residential space identifier 212 may be associated with a type of accommodation associated with the specific geographic location 206 of the first user profile 204A. In operation 1324, a visual representation associated with the accommodation may be generated (e.g., using the view module 312 of FIG. 3).

FIG. 13C is a continuation of the process flow of FIG. 13B illustrating additional processes, according to one embodiment. In operation 1326, the visual representation associated with the first residential space identifier 212A may be displayed (e.g., using the display view 404 of FIG. 4). In operation 1328, a wiki profile (e.g., the wiki profiles 408 of FIG. 4) associated with the first user profile 204A may be generated (e.g., using the wiki profile module 308 of FIG. 3). In operation 1330, the wiki profile 408 associated with the first user profile 204A may be displayed (e.g., displayed in the display view 404 of FIG. 4 using the display module 112 of FIG. 1). In operation 1332, content (e.g., the content 410 of FIG. 4) associated with the wiki profile 408 may be generated. In operation 1334, the content 410 associated with the wiki profile 408 may be displayed.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or Digital Signal Processor (DSP) circuitry). For example, the community network module 106, the map module 108, the residential space identifier module 110, the display module 112, the additional modules 114, the search module 302, the reservation module 304, the online payment module 304A, the attraction module 306, the wiki profile module 308, the append module 310, and the view module 312 of FIGS. 1-10 may be enabled using a community network circuit, a map circuit, a residential space identifier circuit, a display circuit, additional circuits, a search circuit, a reservation circuit, an online payment circuit, an attraction circuit, a wiki profile circuit, an append circuit, and a view circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
generating a community network of user profiles, each user profile of the user profiles associated with a specific geographic location;
generating a first residential space identifier associated with a first user profile of the user profiles; and
generating a first display view to include a three-dimensional map view embodied by the community network, the first residential space identifier, and the first user profile of the user profiles represented at a location in the three-dimensional map view associated with the specific geographic location of the first user profile of the user profiles.

2. The method of claim 1, further comprising:
simultaneously representing other user profiles adjacent to the first user profile of the user profiles in the three-dimensional map view.

3. The method of claim 1, further comprising:
generating residential space identifiers, each residential space identifier of the residential space identifiers associated with a user profile of the user profiles;
generating a search of the residential space identifiers based on at least one criterion;
identifying at least one residential space identifier of the residential space identifiers matching the at least one criterion; and
generating a second display view to include a three-dimensional map view embodied by the community network, the at least one residential space identifier, and a second user profile of the user profiles associated with the at least one residential space identifier of the residential space identifiers represented at a location in the three-dimensional map view associated with the specific geographic location associated with the second user profile of the user profiles.

4. The method of claim 1, further comprising:
displaying reservation information in the first display view.

5. The method of claim 4, further comprising:
generating an online reservation and a financial transaction associated with the first residential space identifier.

6. The method of claim 1, further comprising:
associating the first residential space identifier with at least one type of accommodation associated with the specific geographic location of the first user profile of the user profiles.

7. The method of claim 6, further comprising:
generating a visual representation associated with the accommodation; and
displaying the visual representation associated with the first residential space identifier.

8. The method of claim 1, further comprising:
generating a wiki profile associated with the first user profile of the user profiles; and
displaying the wiki profile associated with the first user profile of the user profiles.

9. The method of claim 8, further comprising:
generating content associated with the wiki profile; and
displaying the content associated with the wiki profile.

10. The method of claim 1 in a form of a machine-readable medium embodying a set of instructions that, when executed by a machine, causes the machine to perform the method of claim 1.

11. A system, comprising:
a geo-spatial environment;
a community network module of the geo-spatial environment, to include user profiles, each user profile of the user profiles to include a specific geographic location;
a residential space identifier module of the geo-spatial environment to generate residential space identifiers associated with accommodations, each residential space identifier of the residential space identifiers associated with a user profile of the user profiles;
a map module of the geo-spatial environment to include map data which serve as a basis to render a three-dimensional map view in the geo-spatial environment which identifies at least some physical structures having specific geographic locations; and
a display module of the geo-spatial environment to generate a display view of the three-dimensional map view embodied by a community network, a first user profile of the user profiles, and a first residential space identifier of the residential space identifiers associated with the first user profile of the user profiles represented at a location in the three-dimensional map view associated with the specific geographic location of the first user profile of the user profiles.

12. The system of claim 11, further comprising:
a search module of the geo-spatial environment to generate search criteria, enable selection of at least one search criterion of the search criteria, and to identify and display the residential space identifiers matching the at least one search criterion of the search criteria.

13. The system of claim 12, wherein the search criteria includes:
a geographic region, a type of accommodation, a rate range, an availability status, a special offer and discounts, an other services availability, and a term lease option.

14. The system of claim 13, wherein the type of accommodation includes:
a house, a room, an apartment, an office suite, and an office.

15. The system of claim 11, further comprising:
a reservation module of the geo-spatial environment to generate a reservation.

16. The system of claim 15, further comprising:
an online payment module to generate an online payment transaction associated with the reservation.

17. The system of claim 11, further comprising:
an attraction module of the geo-spatial environment to generate and display attraction identifiers, each attraction identifier associated with an attraction in a geographic proximity to a specific geographic location associated with a user profile of the user profiles.

18. The system of claim 11, further comprising:
a wiki profile module of the geo-spatial environment to generate in the display view, a wiki profile associated with a user profile of the user profiles.

19. The system of claim 18, further comprising:
an append module of the geo-spatial environment to generate, with at least one wiki profile, content associated with the at least one wiki profile.

20. The system of claim 19, wherein the content includes at least one review associated with the first residential space identifier of the residential space identifiers.

21. The system of claim 11, further comprising:
a view module to generate at least one view of an accommodation associated with the first residential space identifier of the residential space identifiers.

22. A geo-spatial environment, comprising:
a first instruction set to enable a community network, to include a map database associated with map data, a user database associated with user profiles, each user profile of the user profiles associated with a specific geographic location identifiable in the map data, and a residential space identifier database associated with residential space identifiers, each residential space identifier of the residential space identifiers associated with a user profile of the user profiles;
a second instruction set integrated with the first instruction set to select a first residential space identifier of the residential space identifiers associated with a first user profile of the user profiles; and
a third instruction set integrated with the first instruction set and the second instruction set to display a three-dimensional map view embodied by the community network, the first user profile of the user profiles, the first residential space identifier, and simultaneously to represent other user profiles adjacent to the first user profile of the user profiles in the three-dimensional map view, wherein the first user profile of the user profiles is displayed at a location in the three-dimensional map view associated with the specific geographic location of the first user profile.

23. The geo-spatial environment of claim 22, further comprising:
a fourth instruction set to generate search criteria, to enable a selection of at least one search criterion of the search criteria, and to identify and display, in the three-dimension map view, at least one residential space identifier of the residential space identifiers matching the at least one search criterion of the search criteria.

24. The geo-spatial environment of claim 22, further comprising:
a fifth instruction set to generate a reservation associated with an accommodation and the first residential space identifier of the residential space identifiers.
